(19) United States
(12) Patent Application Publication
(10) Pub. No.: US 2025/0069447 A1
(43) Pub. Date: Feb. 27, 2025

(54) Identifying a Road Condition on the Basis of Measured Data from Inertial Sensors of a Vehicle

(71) Applicant: Robert Bosch GmbH, Stuttgart (DE)

(72) Inventor: Simon Weissenmayer, Flein (DE)

(21) Appl. No.: 18/725,401

(22) PCT Filed: Jan. 3, 2023
(86) PCT No.: PCT/EP2023/050042

§ 371 Date: Jun. 28, 2024

(30) Foreign Application Priority Data
Jan. 10, 2022 (DE) 10 2022 200 159.1

(51) Int. Cl. G07C 5/02

(52) U.S. Cl. CPC G07C 5/02

(57) ABSTRACT

A method for identifying a road condition on the basis of measured data from inertial sensors of a vehicle includes (i) receiving the measured data, the measured data indicating an acceleration and/or yaw rate of the vehicle measured by the inertial sensors, (ii) determining noise values indicating the intensity of noise in the measured data, and (iii) identifying the road condition according to the noise values.

### FIELD OF THE INVENTION

The invention relates to a method for identifying a road condition on the basis of measured data from inertial sensors of a vehicle. The invention also relates to a controller and a computer program for carrying out such a method, as well as a computer-readable medium on which the computer program is stored.

### THE PRIOR ART

For example, to identify a road condition, ultrasonic data provided by ultrasonic sensors installed in a vehicle may be evaluated. For example, the ultrasonic data may be used to identify whether a road on which the vehicle is currently travelling is wet or dry. However, ambient noise, such as noise from other vehicles, may interfere with such acoustic identification.

### DISCLOSURE OF THE INVENTION

In light of this, a method for identifying a road condition on the basis of measured data of inertial sensors of a vehicle, a corresponding controller, a corresponding computer program and a corresponding computer readable medium according to the independent claims are presented in the following. Advantageous embodiments of and improvements to the approach presented herein will follow from the description and are described in the dependent claims.

### Advantages of the Invention

Embodiments of the present invention enable identifying a road condition on the basis of acceleration and/or yaw rate values, such as measured by inertial sensors installed in the vehicle as standard. Thus, retrofitting of an additional sensor for identifying the road condition, such as an ultrasonic sensor, can be omitted.

In principle, an inertial sensor, also referred to as an inertial measurement unit or IMU for short, is significantly more robust compared to ambient noises or reflections of noises, for example on guardrails or tunnel walls, because it primarily measures the acoustics transmitted from the tires of the vehicle to the supporting structure thereof. In addition, interference from vehicle movements that occur, for example when braking, accelerating or steering, can usually be well estimated and thus compensated for accordingly. Another advantage is that inertial sensors are present in many vehicles as standard, for example as a component of a controller installed in the vehicle, in particular a controller configured to stabilize driving dynamics.

A first aspect of the invention relates to a computer-implemented method for identifying a road condition on the basis of measured data of inertial sensors of a vehicle. The method comprises at least the following steps: receiving the measured data, the measured data indicating an acceleration and/or yaw rate of the vehicle measured by inertial sensors; determining noise values indicating the intensity of noise in the measured data; and identifying the road condition according to the noise values.

For example, the method may be carried out automatically by a processor of a controller of the vehicle. The controller may be additionally configured to perform one or more driver assistance functions, such as ABS or ESP, on the basis of the measured data that may be used to steer, accelerate, and/or brake the vehicle according to the road condition identified, such as to stabilize the vehicle. For this purpose, the vehicle may comprise a corresponding actuator system, for example in the form of a steering actuator, a brake actuator, an electric drive motor or a combination of at least two of these examples. For example, the measured data may be used by the controller to identify the road condition on the basis of the noise values and in addition to stabilize the vehicle on the basis of the measured acceleration(s) and/or yaw rate(s) of the vehicle.

The inertial sensors may be installed in the vehicle, wherein the measured data is generated and output by the inertial sensors during operation of the vehicle and may be received in the controller. For example, the inertial sensors may be integrated into the controller.

The vehicle may be a motor vehicle, such as a car, truck, bus, or motorcycle. In a broader sense, a vehicle may also be understood to mean an autonomous, mobile robot.

The term “road condition” may be understood to mean a condition of a road on which the vehicle is currently traveling. For example, the road condition may be identified by assigning the noise values one of a plurality of predetermined classes, such as “wet”, “dry”, “smooth” or “grippy”, a value quantifying the wetness and/or dryness of the road, a value quantifying the risk of aquaplaning of the vehicle, or a combination of at least two of these examples. This assignment may be performed, for example, using one or more characteristic curves or one or more characteristics maps identified in previous driving trials. The characteristic curves or the characteristic maps may be stored in the controller, for example in the form of one or more mathematical functions or one or more look-up tables.

The method described above and below is based on the knowledge that tire noise propagates from the tires to the inertial sensors as structure-borne sound and can be identified by it. Surprisingly, it could be observed in trials that the noise in the measured data generated by the inertial sensors changes significantly depending on the road condition. In particular, it could be shown that the noise becomes significantly stronger when the vehicle changes from a dry road to a wet road, and in the reverse case, becomes significantly weaker. Thus, such a change in the intensity of the noise allows a conclusion to be drawn about a current road condition or a change between two road conditions, for example between “dry”, “wet” or “damp”. For example, the effect may be utilized to calculate or correct a coefficient of friction indicating an estimated friction between the wheels and the road, or estimate a probability of aquaplaning.

A second aspect of the invention relates to a controller comprising a processor configured to carry out the method described above and in the following. The controller may comprise hardware and/or software modules. In addition to the processor, the controller can comprise a memory and data communication interfaces for data communication with peripheral devices. Features of the method may also be considered features of the controller and vice versa.

Further aspects of the invention relate to a computer program and a computer-readable medium on which the computer program is stored.

The computer program comprises instructions that, when the computer program is executed by a processor, cause said processor to carry out the method described above and in the following.

The computer-readable medium can be a volatile or non-volatile data memory. The computer-readable medium can be a hard drive, a USB memory device, a RAM, ROM, EPROM or flash memory, for example. The computer-readable medium can also be a data communication network such as the Internet or a data cloud, which enables downloading a program code.

Features of the method described above and in the following can also be considered features of the computer program and/or computer-readable medium, and vice versa.

Possible features and advantages of the embodiments of the invention can be considered among other things and without limiting the invention, to be on the basis of the ideas and insights described in the following.

According to one embodiment, the measured data may comprise measured values for at least two different measurement dimensions. In so doing, noise values indicating an intensity of a noise associated with the measurement dimension may be determined from the measured values of each measurement dimension. The road condition may then be identified according to the noise levels of different measurement dimensions. For example, “measuring dimension” may be understood to mean longitudinal, transverse, or vertical acceleration, or a roll, pitch, or yaw rate of the vehicle. In trials, it could be observed that the noise in the measured data is influenced to varying degrees by changes in the speed of the vehicle, depending on the measurement dimension. In other words, it has been found that there are measurement dimensions that are less influenced by changes in the speed of the vehicle than other measurement dimensions, and are therefore particularly suitable for identifying the road condition on the basis of the noise. Particularly suitable measurement dimensions are, for example, the vertical acceleration, the roll rate and the pitch rate. In principle, however, other common measurement dimensions are also suitable for the method.

According to one embodiment, the noise values may be determined at different predetermined frequency ranges, particularly in three to eight different predetermined frequency ranges. Preferably, the noise values may be determined in three to four different predetermined frequency ranges. The frequency ranges may differ from one another in their bandwidth and/or their limits. This may improve the identification accuracy of the method. By way of example, a first, low frequency range of between 100 Hz and 200 Hz, a second, mid-frequency range of between 200 Hz and 500 Hz, and/or a third, high frequency range of between 500 Hz and a maximum frequency of the inertial sensors, wherein the maximum frequency may be 1 kHz, for example. The wet hissing sound often affects rather high frequency ranges, while noise interference often affects rather low frequency ranges. If the noise in high frequency ranges is high compared to the noise in low frequency ranges, then the noise may be associated with the wet hissing sound of the wheels.

According to one embodiment, the measured data and/or data on the basis of the measured data may be input as input data into a smoothing filter to obtain output data that is smoothed with respect to the input data, i.e., contains no noise or significantly less noise than the measured data. In so doing, a difference may be formed between the input data and the output data. The noise values may then be determined from the difference. A straightening filter can be understood as a low pass filter, for example a rectangular or Gaussian filter. This allows the noise to be filtered out of the measured data with little computational effort.

According to one embodiment, the difference may be squared to obtain the noise values. This may reduce inaccuracies in determining noise values.

According to one embodiment, the measured data may be received in multiple successive time steps. The noise values can be determined in a current time step from the measured data of different time steps. For example, the noise values may be determined using one, two, or more than two earlier time steps, each preceding the current time step. For example, the noise values may be determined from the measured data of multiple successive time steps. For example, it is conceivable that average noise values are determined from the measured data of different time steps. In this way, measurement inaccuracies can be compensated. For example, the time steps may each be 0.1 milliseconds, 1 milliseconds, or 5 milliseconds.

According to one embodiment, the measured data of various time steps may be input into an edge filter to obtain filter data in which noise is amplified from the measured data. In so doing, the noise values may be determined from the filter data. The term “edge filter” may generally be understood to mean a high pass filter or edge operator configured to amplify changes in intensity of noise. For example, the edge filter may be a Laplace filter, a Sobel operator, or a Prewitt operator. However, the use of a non-linear filter is also conceivable. In this way, road condition identification may be further improved.

According to one embodiment, the noise values may be determined by squaring the filter data. This may reduce the computational effort involved in performing the method.

According to one embodiment, the filter data may be input into the smoothing filter as the input data (see above). Stated differently, the noise values may be determined by forming the difference from the filter data and the output data resulting from suppression or attenuation of the noise in the filter data by means of the smoothing filter. As a result, the noise amplified by the edge filter may be filtered out of the filter data with little computational effort.

According to one embodiment, the road condition may additionally be detected according to a current speed of the vehicle. It has been observed in trials that noise varies not only according to how wet the road is, but also according to the speed of the vehicle. Evaluating the noise values in combination with the current speed of the vehicle thus increases the reliability of the method.

According to one embodiment, at least one detection value indicating a degree of wetness of a road of the vehicle and/or a risk of aquaplaning for the vehicle may be determined to identify the road condition. The term “detection value” may be understood to mean, for example, a Boolean value or a value from a continuous range of values, for example a percentage value. For example, the detection value may be read from a lookup table that associates different detection values with different noise values. The detection values may optionally be associated with further values in the lookup table, for example possible values for a current speed of the vehicle or statistical values (see below).

According to one embodiment, additional statistical values may be determined indicating a variance with respect to the measured data and/or the noise values. The road condition can additionally be detected according to the statistical values. The statistical values may have been determined in trials, for example, and stored in the form of one or more characteristic curves or one or more characteristic maps in the controller. In this way, the robustness of the method can be increased against random interference.

### BRIEF DESCRIPTION OF THE DRAWINGS

Embodiments of the invention are described in the following with reference to the accompanying drawings, wherein neither the drawings nor the description are to be construed as limiting the invention.

FIG. 1 shows a vehicle comprising a controller according to one embodiment of the invention.

FIG. 2 shows the controller of FIG. 1 in detail.

FIG. 3 shows a graph that compares a time curve of a speed of the vehicle of FIG. 1 with a time curve of a noise measured by inertial sensors of the vehicle of FIG. 1.

The figures are merely schematic and are not to scale. Identical reference signs in the figures denote identical or functionally identical features.

### EMBODIMENTS OF THE INVENTION

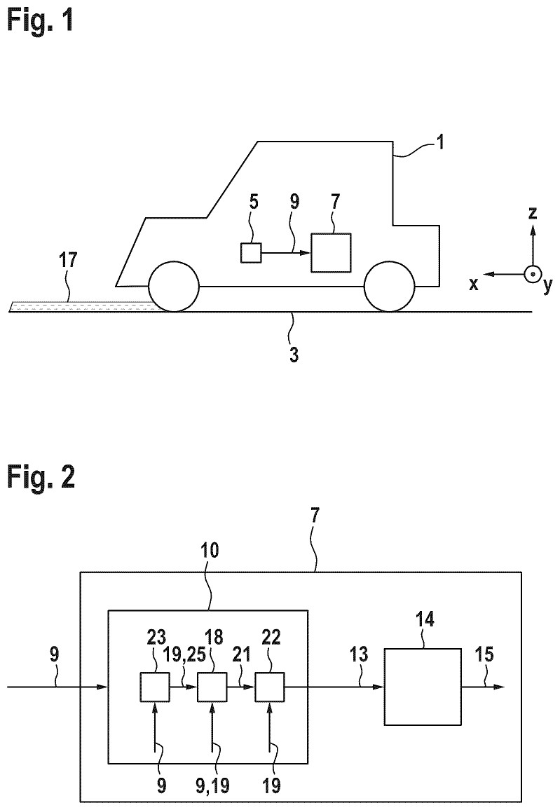

FIG. 1 shows a vehicle 1 traveling on a road 3. In this example, the vehicle 1 is equipped with inertial sensors 5 in the form of a 6D sensor, which is configured to measure accelerations and yaw rates of the vehicle 1, with respect to an x, y and z direction respectively.

Furthermore, the vehicle 1 comprises a controller 7 configured to receive and evaluate measured data 9 generated by inertial sensors 5.

The inertial sensors 5 are arranged here as an example outside of the controller 7 in the vehicle 1. However, it is also possible that inertial sensors 5 are integrated into the controller 7.

For example, controller 7 may perform a driver assistance function configured to steer, accelerate, and/or brake the vehicle 1 on the basis of the measured data 9. Details of controller 7 are shown in FIG. 2.

For example, the driver assistance function may include identifying a road condition of the road 3 in the method described below.

As can be seen in FIG. 2, the measured data 9 is received in a first step of the method in controller 7. The measured data 9 may be received in several successive time steps. For example, in each time step, three measured values for the accelerations aₓ, a_{y}, a_{z} and three measured values for the yaw rates ωₓ, ω_{y}, ω_{z} may be received.

In a second step, a noise determination module 10 determines noise values 13 from the measured data 9 that indicate an intensity of a noise in the measured data 9. For example, the noise values 13 may be determined for each of the six aforementioned measurement dimensions.

Additionally or alternatively, the noise values 13 may be determined from the intensities of the noise at various predetermined frequency ranges.

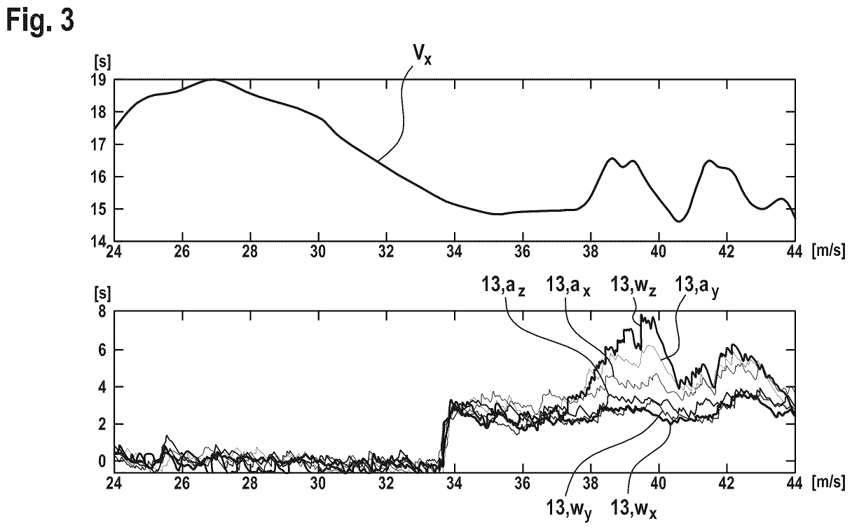

In a third step, noise values 13 are evaluated in a detection module 14 to identify the road condition. For example, detection module 14 may determine a detection value 15 indicating whether road 3 is wet or dry on the basis of noise values 13. In the example shown in FIG. 1, the vehicle 1 is traveling straight into a wet portion 17 of the road 3. This is associated with a sudden increase in intensity of noise in the measured data 9 that is detected by the detection module 14 as a change in road condition from “dry” to “wet” (also see FIG. 3). Accordingly, the detection value 15 here indicates the road condition “wet”.

Thus, the detection value 15 may be a wet value, which, as here, may indicate various discrete road conditions or different degrees of wetness of the road 3. Additionally or alternatively, the detection module 14 may output a risk of aquaplaning value indicating a risk of aquaplaning for the vehicle 1 as the detection value 15.

FIG. 3 exemplarily shows a time curve of a longitudinal speed vₓ of the vehicle 1. Below this, the corresponding (filtered) noise values 13 are plotted from the measurements of the accelerations aₓ, a_{y}, a_{z} and the measurements of the yaw rates ωₓ, ω_{y}, ω_{z}. The vehicle 1 brakes from 19 m/s to 15 m/s. Shortly before second 34, the vehicle 1 reaches the wet portion 17, which consists of watered tiles and remains largely stable. Shortly before second 38, the vehicle 1 accelerates, thereby becoming unstable. The longitudinal speed change and the instability have a great impact on the longitudinal accelerationaₓ, the transverse acceleration a_{y} and the yaw rate ω_{z} and thus also on their noise values 13. As can be seen in FIG. 3, the noise values 13 of the remaining dimensions are significantly more robust compared to vehicle movements.

As can be seen in FIG. 2, controller 7 may optionally include a smoothing filter 18 into which the measured data 9 is input as input data 19 in each time step and which converts the input data 19 to output data 21 in which the noise is suppressed or at least strongly attenuated. The noise values 13 may then be determined from the output data 21.

The noise values 13 w may be determined, for example, by calculating the quadratic deviations between the (raw) measured data 9, z_{raw} as the input data 19, and the filtered measured values z_{filt} as the output data 21 in a calculation module 22:

$$w = {( {z}_{raw} - {z}_{filt} )}^{2}$$

An edge filter 23 may optionally be upstream of the smoothing filter 18, in which the measured data 9 is input in each time step and which generates filter data 25 from the measured data 9 of multiple successive time steps, for example of two, three or more successive time steps, in which the noise is significantly amplified by differentiation compared with the measured data 9. The filter data 25 may then be input as the input data 19 into the smoothing filter 18 to obtain the output data 21.

For example, the measured data 9 z_{raw} may be processed using a Laplace filter such that a second derivative z_{Δ,k} of the measured data 9 is approximated using the measured data 9, z_{raw,k} a current time stepk, the measured data 9, z_{raw,k-1} a first time step immediately preceding the current time step k, and the measured data 9, z_{raw,k-2} a second time step immediately preceding the first time step:

$${z}_{Δ , k} = {z}_{raw , k - 2} - 2 {z}_{raw , k - 1} + {z}_{raw , k}$$

The resulting filter data 25, z_{Δ} may then be filtered with the smoothing filter 18 to z_{Δ,filt} obtain the output data 21.

Finally, the noises 13 w may be calculated in the calculation module 22 using:

$$w = {( {z}_{Δ} - {z}_{Δ , filt} )}^{2}$$

The more often the derivation is performed and thus the noise is amplified and the greater the filter time constant is selected, the smaller the deviation z_{Δ,filt} from zero relative to z_{Δ}. To save computational time, the noise values 13 w may therefore, also be calculated directly by squaring the derivative z in the calculation module 22:

$$w = {( {z}_{Δ} )}^{2}$$

For example, the detection value 15 may be utilized to better predict a coefficient of friction indicating friction between the wheels of the vehicle 1 and the road 3. For example, if the ambient temperature is greater than 4° C. and the road 3 is detected as dry, a coefficient of friction of at least 0.6 may be assumed. This results in, for example, an ABS function building up more braking pressure more quickly than if the road 3 is detected as wet or the ambient temperature is below 4° C.

At very high speeds, the coefficient of friction for a very wet road 3 can be significantly below 0.6 and in particular become so small, particularly due to aquaplaning, that the vehicle 1 is difficult to control. The risk of aquaplaning is substantially proportional to the intensity of the noise, whereas the coefficient of friction is substantially anti-proportional to the intensity of the noise. The braking forces may thus be adjusted to the measured noise.

It is possible that in each measurement step, a plurality of detection values 15 is calculated from a plurality of noise values 13. For example, the detection values 15 may be determined by evaluating noise levels in different measurement dimensions and/or frequency ranges, particularly in two to eight, preferably in three to four different frequency ranges.

For example, all detection values 15 of a measurement step may be merged together as follows.

The merge may take into account an individual variance σᵢ² of each individual measurement. The individual detection value 15 μᵢ for each noise value 13 and the corresponding variance σᵢ² can be determined on the basis of tests, for example, according to different vehicle speeds v or wetness levels μ, and stored in characteristic maps or characteristic curves in the controller 7, and thus calculated from the respective characteristic map or characteristic curve during vehicle operation:

$${μ}_{i} = KF ( {w}_{i} , v ) or {μ}_{i} = KL ( {w}_{i} ) ;$$

$${σ}_{i}^{2} = KF ( {w}_{i} , v ) and / or {σ}_{i}^{2} = KF ( v , μ ) or {σ}_{i}^{2} = KL ( {w}_{i} ) and / or {σ}_{i}^{2} = KL ( μ )$$

For the subsequent calculation of the weighted average μₛ of a sensor, i.e., a measurement dimension, the variance σ_{s,r}² of the sensor may first be calculated from the reciprocal sum of its reciprocal variances σᵢ²:

$${σ}_{s , r}^{2} = \frac{1}{{\sum }_{i} \frac{1}{{σ}_{i}^{2}}}$$

The lower the individual standard deviationσᵢ, the greater the detection value 15 μᵢ is weighted when calculating the individual sensor detection value 15 μₛ:

$${μ}_{s} = {σ}_{s , r}^{2} {\sum }_{i} \frac{{μ}_{i}}{{σ}_{i}^{2}}$$

Interference often affects the measurements of a measurement step of a sensor to varying degrees and thus leads to particularly large differences in the detection values 15 μᵢ of a sensor. All detection values 15, μᵢ from sensors influenced by interferences, should therefore have a lower weight when calculating a merged detection value across multiple sensors. Interference that affects the measurements of a measurement step to varying degrees should lead to a correspondingly greater value for the variance of the merged detection value. Measurements for which a high variance is to be expected due to measurement noise, according to experience, should be weighted less heavily when calculating the variance of the merged detection value. For this reason, in a further step, a weighted sensor-specific variance σ_{s,w}² can be calculated from the deviations of the detection values 15, μᵢ from the weighted average μₛ and the variance σ_{s,r}²:

$${σ}_{s , w}^{2} = {σ}_{s , r}^{2} {\sum }_{i} \frac{{( {μ}_{i} - {μ}_{s} )}^{2}}{{σ}_{i}^{2}}$$

This weighted variance σ_{s,w}² is greater the more the detection values 15 μᵢ deviate from the weighted average μₛ, as long as these differences are not due to a high variance σᵢ², which is to be expected due to the known measurement noise.

An overall variance σₛ² is then calculated from the two previously calculated variances:

$${σ}_{s}^{2} = {σ}_{s , r}^{2} + {σ}_{s , w}^{2}$$

The overall variance σₛ² is large if all individual variances σᵢ² are large due to the expected measurement noise. However, it is also large if the individual variances σᵢ² are small due to the expected measurement noise, while the detection values 15 μᵢ differ greatly. However, the overall variance σₛ² may be small if one of the measured values deviates greatly, while a high variance was determined for that measured value due to the expected measurement noise.

Interference due to vehicle movements, e.g., accelerating, braking or steering, have a greater effect on the noise values 13 of the longitudinal acceleration, lateral acceleration, and yaw rate measurement dimensions, hereinafter referred to as the first measurement dimensions, than on those of the vertical acceleration, roll, and pitch rate measurement dimensions, hereinafter referred to as the second measurement dimensions. To be as robust as possible against interferences, the first measurement dimensions may first be merged together in a first merge and the second measurement dimensions may be merged together in a second merge. Subsequently, the results of both merges may be merged together.

Alternatively, the measured data 9 and/or the noise values 13 may be input into a machine learning algorithm trained on historical measured data and/or historical noise values to calculate the detection values 15 and/or merged detection values from the measured data 9 and/or the noise values 13.

Lastly, it should be noted that terms such as “comprising,” “including”, etc. do not exclude other elements or steps, and indefinite articles such as “a” or “an” do not exclude a plurality. Reference signs in the claims should not be construed as limitations.

1. A method for identifying a road condition on the basis of measured data from inertial sensors of a vehicle, comprising:
receiving the measured data, wherein the measured data indicates an acceleration and/or yaw rate of the vehicle measured by the inertial sensors;
determining noise values indicating an intensity of a noise in the measured data; and
identifying the road condition according to the noise values.

2. The method according to claim 1, wherein:
the measured data comprises measured values for at least two different measurement dimensions;
noise values are determined from the measured values of each measurement dimension, which indicate an intensity of a noise associated with the measurement dimension; and
the road condition is identified according to the noise values of different measurement dimensions.

3. The method according to claim 1, wherein the noise values are determined at different predetermined frequency ranges.

4. The method according to claim 1, wherein:
the measured data and/or measured data on the basis of the measured data are input as input data into a smoothing filter to obtain output data smoothed against the input data;
a difference is formed between the input data and the output data; and
the noise values are determined from the difference.

5. The method according to claim 4, wherein the noise values are determined by squaring the difference.

6. The method according to claim 1, wherein the measured data are received in a plurality of successive time steps and the noise values are determined in a current time step from the measured data of different time steps.

7. The method according to claim 6, wherein:
the measured data of different time steps are input into an edge filter to obtain filter data in which the noise is amplified against the measured data; and
the noise values are determined from the filter data (25).

8. The method according to claim 7, wherein the noise values are determined by squaring the filter data.

9. The method according to claim 4, wherein:
the measured data are received in a plurality of successive time steps and the noise values are determined in a current time step from the measured data of different time steps;
the measured data of different time steps are input into an edge filter to obtain filter data in which the noise is amplified against the measured data;
the noise values are determined from the filter data; and
the filter data is input into the smoothing filter as the input data.

10. The method according to claim 1, wherein at least one detection value indicating a degree of wetness of a road of the vehicle and/or a risk of aquaplaning for the vehicle is determined to identify the road condition.

11. The method according to claim 1, wherein the road condition is additionally identified according to a current speed of the vehicle.

12. The method according to claim 1, wherein:
additional statistical values are determined indicating a variance with respect to the measured data and/or the noise values; and
the road condition is additionally identified according to the statistical values.

13. A controller comprising a processor configured to perform the method according to claim 1.

14. A computer program comprising instructions which, when the computer program is performed by a processor, cause a processor to carry out the method according to claim 1.

15. A computer-readable medium on which the computer program according to claim 14 is stored.

16. The method according to claim 1, wherein the noise values are determined at three to eight different predetermined frequency ranges.
